(19) United States
(12) Patent Application Publication
(10) Pub. No.: US 2004/0205008 A1
(43) Pub. Date: Oct. 14, 2004

(54) Systems and methods for computing cash flows

(76) Inventors: Robert M. Haynie, Shoreline, WA (US); Mark Schneider, Ridgewood, NJ (US); Glenn Hascher, Stamford, CT (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/811,779

(22) Filed: Mar. 29, 2004

(51) Int. Cl. G06F 17/60

(52) U.S. Cl. 705/31

(57) ABSTRACT

Systems and methods for computing cash flows are described. In some embodiments, the systems and methods compute cash flows of taxpayers based on applying user computation rules and user options for treating recurring and non-recurring cash flow items to verified tax data and verified financial data of the taxpayers.

### BACKGROUND

A cash flow refers to an availability of cash based on incomes and expenses. A lending underwriter (“underwriter”) can compute a cash flow of a borrower to determine whether to grant a loan to the borrower.

A variety of methods are currently available for computing cash flows. In some methods, underwriters compute cash flows based on manually entering data from income tax returns (e.g., U.S. income tax returns) provided by the borrower into a spreadsheet and applying their own cash flow computation rules to the data. Such methods can lack accuracy because the underwriters can make mistakes in data entry, and because the income tax returns provided by the borrower can be different than the income tax returns filed by the borrower with a governmental tax collection entity (e.g., the U.S. Internal Revenue Service (IRS)). Such methods can also lack consistency because the underwriters can use subjective computation rules that vary from underwriter to underwriter.

### SUMMARY

Systems and methods for computing cash flows and providing verified tax data are described.

In embodiments, methods for providing verified tax data include providing databases of verified tax data files, where each verified tax data file: (1) includes verified tax data of a taxpayer and (2) is associated with a taxpayer identifier identifying the taxpayer and requesting party identifiers identifying respective requesting parties having access rights to the verified tax data file.

The methods further include receiving a request from a first requesting party for verified tax data of a first taxpayer, querying the databases to determine whether they include verified tax data files that are associated with a first taxpayer identifier and a first requesting party identifier, and providing the verified tax data included in the found verified tax data files to the first requesting party.

In one aspect, the verified tax data included in each of the verified tax data files is based on data elements from tax forms filed by a taxpayer with a governmental tax collection entity.

In one aspect, the verified tax data included in each of the verified tax data files is based on data elements from verified tax transcripts of a governmental tax collection entity, such as the IRS. The verified tax transcripts can be obtained based on a requesting party providing an IRS Form 4506, an IRS Form 8821, and/or another similar IRS form executed by a taxpayer. The verified tax transcripts can be digitized using optical character recognition schemes and/or manual data entry schemes.

In one aspect, a verified tax data file is associated with an individual taxpayer, a joint taxpayer, or a non-personal taxpayer. The taxpayer identifier for a joint taxpayer can include a taxpayer identifier for one or both of the individual taxpayers included in the joint taxpayer.

In some embodiments, the methods further include returning to querying the databases based on not finding one or more verified tax data files that are associated with the first taxpayer identifier and the first requesting party identifier. Returning to querying the databases can include storing the request from the first requesting party for the verified tax data of the first taxpayer, receiving additional verified tax data files, and updating the one or more databases to include the additional verified tax data files.

In some embodiments, the methods further include computing a cash flow of the first taxpayer. The methods can compute the cash flow based on applying computation rules to the verified tax data of the first taxpayer.

In some embodiments, the methods apply computation rules and computation options for treating recurring and/or non-recurring cash flow items to the verified tax data and/or financial data of the first taxpayer. The financial data includes data other than verified tax data that relates to incomes and/or expenses of the taxpayer (e.g., data other than that reported to a governmental tax collection entity).

Systems for computing cash flows are also described. In embodiments, the systems include databases of verified tax data files and a server that is in communication with the databases and configured to execute features of the previously described methods.

Processor programs for computing cash flows are also described. The processor programs are stored on processor-readable mediums and, in embodiments, include instructions to cause a processor to execute features of the previously described methods.

These and other features of the systems and methods described herein can be more fully understood by referring to the following detailed description and accompanying drawings.

### BRIEF DESCRIPTION OF THE DRAWINGS

FIG. 1 schematically illustrates an exemplary system for computing cash flows.

FIGS. 2A-2I schematically illustrate exemplary displays of graphical user interfaces that facilitate computation of cash flows.

FIGS. 3A-3D schematically illustrate an embodiment of a method for computing cash flow in the exemplary system of FIG. 1.

FIG. 4 schematically illustrates an embodiment of a method for updating data in the exemplary system of FIG. 1.

### DETAILED DESCRIPTION

Illustrative embodiments will now be described to provide an overall understanding of the disclosed systems and methods. One or more examples of the illustrative embodiments are shown in the drawings. Those of ordinary skill in the art will understand that the disclosed systems and methods can be adapted and modified to provide systems and methods for other applications, and that other additions and modifications can be made to the disclosed systems and methods without departing from the scope of the present disclosure. For example, features of the illustrative embodiments can be combined, separated, interchanged, and/or rearranged to generate other embodiments. Such modifications and variations are intended to be included within the scope of the present disclosure.

Generally, the disclosed systems and methods relate to computing a cash flow of a taxpayer based on verified tax data of the taxpayer. As described herein, the verified tax data of a taxpayer includes data filed by the taxpayer with a governmental tax collection entity and obtained directly and/or indirectly from the governmental tax collection entity. In embodiments, the disclosed systems and methods receive requests from users for computing cash flows of taxpayers, obtain verified tax data of the taxpayers, apply user computation rules and user options for treating non-recurring cash flow items to the verified tax data, and provide the computed cash flows and the verified tax data to the users. In embodiments, the disclosed systems and methods store the verified tax data and the computed cash flows in a database, associate the stored verified tax data and computed cash flows with taxpayer and user identifiers, and regulate user access to the data in the database based on the user identifiers.

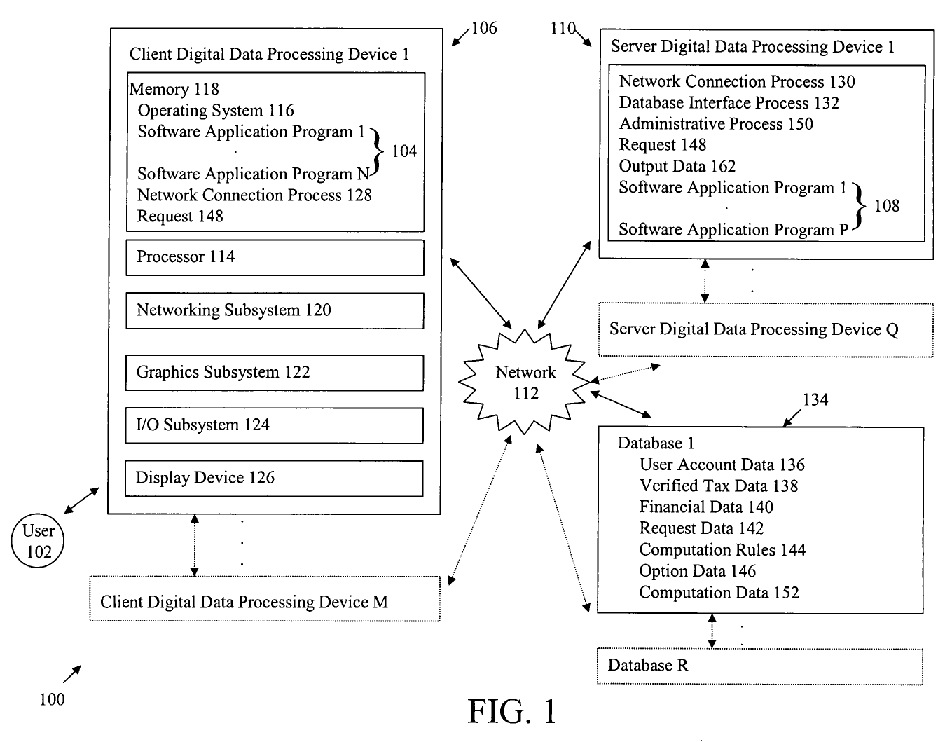

FIG. 1 schematically illustrates an exemplary system for computing cash flows. As shown in FIG. 1, the illustrated system 100 includes one or more client digital data processing devices 106 (“client”), one or more server digital data processing devices 110 (“server”), and one or more databases 134. The client 106, the server 110, and the database 134 communicate using one or more data communications networks 112 (“networks”).

In FIG. 1, the features in a digital data processing device are shown as residing in the client 106. Those of ordinary skill in the art will understand that one or more of the features of the client 106 can be present in the server 110.

Generally, references herein to a “client” and a “server” are used to differentiate two communicating devices and/or sets of processor instructions. References herein to a client and/or a server can thus be understood to be references to communications originating from a client and/or a server as these terms are understood by those of ordinary skill in the art. Such communications can be based on or otherwise initiated from one or more input devices (e.g., a keyboard, a stylus, a mouse, etc.) controlled by a user. Also, references herein to a client and/or a server can thus be understood to include one or more processor-controlled devices that act in a client-server (i.e., request-response) model, in which the client and the server can reside on the same processor-controlled device, and in which, based on perspective, the client can act as a server, and the server can act as a client.

As shown in the system 100 of FIG. 1, a user 102 desiring to compute a cash flow can execute one or more software application programs 104 (such as, for example, an Internet browser and/or another type of application program capable of providing an interface to a cash flow computation program) residing on the client 106 to generate data messages that are routed to, and/or receive data messages generated by, one or more software application programs 108 (e.g., cash flow computation programs) residing on the server 110 via the network 112. A data message includes one or more data packets, and the data packets can include control information (e.g., addresses of the clients and the servers 106, 110, names/identifiers of the software application programs 104, 108, etc.) and payload data (e.g., data relevant to compute a cash flow, such as a request to compute a cash flow 148 and output data 162 including a computed cash flow).

The software application programs 104 can include one or more software processes (e.g., a calculation process/engine) executing within one or more memories 118 of the client 106. Similarly, the software application programs 108 can include one or more software processes executing within one or more memories of the server 110. The software application programs 108 can include one or more sets of instructions and/or other features that can enable the server 110 to compute a cash flow. As described herein, the software application program 108 can include instructions for processing verified tax data 138 and, in some embodiments, financial data 140, to generate output data 162. The software application programs 104, 108 can be provided using a combination of built-in features of one or more commercially available software application programs and/or in combination with one or more custom-designed software modules. Although the features and/or operations of the software application programs 104, 108 are described herein as being executed in a distributed fashion (e.g., operations performed on the networked client and servers 106, 110), those of ordinary skill in the art will understand that at least some of the operations of the software application programs 104, 108 can be executed within one or more digital data processing devices that can be connected by a desired digital data path (e.g. point-to-point, networked, data bus, etc.).

The digital data processing device 106, 110 can include a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data. A processor 114 refers to the logic circuitry that responds to and processes instructions that drive digital data processing devices and can include, without limitation, a central processing unit, an arithmetic logic unit, an application specific integrated circuit, a task engine, and/or combinations, arrangements, or multiples thereof.

The instructions executed by a processor 114 represent, at a low level, a sequence of “0's” and “1's” that describe one or more physical operations of a digital data processing device. These instructions can be pre-loaded into a programmable memory (e.g., an electrically erasable programmable read-only memory (EEPROM)) that is accessible to the processor 114 and/or can be dynamically loaded into/from one or more volatile (e.g., a random-access memory (RAM), a cache, etc.) and/or non-volatile (e.g., a hard drive, etc.) memory elements communicatively coupled to the processor 114. The instructions can, for example, correspond to the initialization of hardware within the digital data processing devices 106, 110, an operating system 116 that enables the hardware elements to communicate under software control and enables other computer programs to communicate, and/or software application programs 104, 108 that are designed to perform operations for other computer programs, such as operations relating to computing cash flows. The operating system 116 can support single-threading and/or multi-threading, where a thread refers to an independent stream of execution running in a multi-tasking environment. A single-threaded system is capable of executing one thread at a time, while a multi-threaded system is capable of supporting multiple concurrently executing threads and can perform multiple tasks simultaneously.

A local user 102 can interact with the client 106 by, for example, viewing a command line, using a graphical and/or other user interface, and entering commands via an input device, such as a mouse, a keyboard, a touch sensitive screen, a track ball, a keypad, etc. The user interface can be generated by a graphics subsystem 122 of the client 106, which renders the interface into an on- or off-screen surface (e.g., on a display device 126 and/or in a video memory). Inputs from the user 102 can be received via an input/output (I/O) subsystem 124 and routed to a processor 114 via an internal bus (e.g., system bus) for execution under the control of the operating system 116.

Similarly, a remote user (not shown) can interact with the digital data processing devices 106, 110 over the network 112. The inputs from the remote user can be received and processed in whole or in part by a remote digital data processing device collocated with the remote user. Alternatively and/or in combination, the inputs can be transmitted back to and processed by the local client 106 or to another digital data processing device via one or more networks using, for example, thin client technology. The user interface of the local client 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can include a networking subsystem 120 (e.g., a network interface card) to establish the communications link between the devices. The communications link interconnecting the digital data processing devices can include elements of a data communications network, a point to point connection, a bus, and/or another type of digital data path capable of conveying processor-readable data.

In one illustrative operation, the processor 114 of the client 106 executes instructions associated with the software application program 104 (including, for example, runtime instructions specified, at least partially, by the local user 102 and/or by another software application program, such as a batch-type program) that can instruct the processor 114 to at least partially control the operation of the graphics subsystem 122 in rendering and displaying a graphical user interface (including, for example, one or more menus, windows, and/or other visual objects) on the display device 126.

The network 112 can include a series of network nodes (e.g., the client and the servers 106, 110) that can be interconnected by network devices and wired and/or wireless communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a server node regardless of dissimilarities in the network topology (e.g., bus, star, token ring), spatial distance (e.g., local, metropolitan, wide area network), transmission technology (e.g., transfer control protocol/internet protocol (TCP/IP), Systems Network Architecture), data type (e.g., data, voice, video, multimedia), nature of connection (e.g., switched, non-switched, dial-up, dedicated, or virtual), and/or physical link (e.g., optical fiber, coaxial cable, twisted pair, wireless, etc.) between the originating and server network nodes.

FIG. 1 shows processes 128, 130, 132, and 150. A process refers to the execution of instructions that interact with operating parameters, message data/parameters, network connection parameters/data, variables, constants, software libraries, and/or other elements within an execution environment in a memory of a digital data processing device that causes a processor to control the operations of the digital data processing device in accordance with the desired features and/or operations of an operating system, a software application program, and/or another type of generic or specific-purpose application program (or subparts thereof). For example, a network connection process 128, 130 refers to a set of instructions and/or other elements that enable the digital data processing devices 106, 110, respectively, to establish a communication link and communicate with other digital data processing devices during one or more sessions. A session refers to a series of transactions communicated between two network nodes during the span of a single network connection, where the session begins when the network connection is established and terminates when the connection is ended. A database interface process 132 refers to a set of instructions and other elements that enable the server 110 to access the database 134 and/or other types of data repositories to obtain access to, for example, user account data 136, verified tax data 138, request data 142, computation rules 144, option data 146, and financial data 140. The accessed information can be provided to the software application program 108 for further processing and manipulation. An administrative process 150 refers to a set of instructions and other features that enable the server 110 to monitor, control, and/or otherwise administer a cash flow computation. For example, the administrative process 150 can a) maintain and update configuration, runtime, and/or session data for the one or more digital data processing devices 106, 110 and/or the software application programs 104, 108 executing on the devices 106, 110, b) provide buffer management, multi-threaded services, and/or data structure management, c) provide initialization parameters to the digital data processing devices 106, 110 and/or the software application programs 104, 108, d) manage groups of objects (e.g., groups of data elements stored on the digital data processing devices 106, 110 and/or stored or otherwise maintained in the database 134, groups of software application programs 104, 108, groups of users authorized to access software application programs 104, 108, groups of licenses, etc.), e) manage relationships between objects in response to messages communicated between the one or more digital data processing devices 106, 110, f) provide one or more support services (e.g., encryption/decryption, compression, path routing, message parsing, message format manipulation, etc.) to the digital data processing devices 106, 110, and/or g) provide load balancing based on, for example, processor usage/availability, network usage/availability, memory usage/availability, software application program usage/availability, message length, and/or message volume.

Those of ordinary skill in the art will recognize that, although the illustrated processes 128, 130, 132, and 150 and their features are described with respect to some embodiments, the illustrated processes and/or their features can be combined into one or more processes. One or more of the illustrated processes 128, 130, 132, and 150 can be provided using a combination of built-in features of one or more commercially available software application programs and/or in combination with one or more custom-designed software modules.

The databases 134 can be stored on a non-volatile storage medium or a device known to those of ordinary skill in the art (e.g., compact disk (CD), digital video disk (DVD), magnetic disk, internal hard drive, external hard drive, random access memory (RAM), redundant array of independent disks (RAID), or removable memory device). As shown in FIG. 1, the databases 134 can be located remotely from the client 106. In some embodiments, the databases 134 can be located locally to the client 106 and/or can be integrated into the client 106. The databases 134 can include distributed databases. The databases 134 can include different types of data content and/or different formats for stored data content. For example, the databases 134 can include tables and other types of data structures.

User account data 136 includes data identifying one or more users of the system 100. Generally, user account data 136 includes data identifying the names, contact information, and login information of the users and user identifiers for the users. The contact information can be based on a wireless and/or a wired telecommunications network and can include one or more of email addresses, facsimile numbers, regular/postal (i.e., non-electronic) mail addresses, and telephone numbers. The login information can include usernames and associated passwords for accessing the system 100. The user identifiers can include alphanumeric identifiers, such as usernames and/or passwords. Alternatively and/or in combination, the user identifiers can be generated based on applying one or more data compression and/or data encryption schemes to the user account data 136. For example, the user identifiers can include compressed and/or encrypted usernames and/or passwords. In some embodiments, user account data 136 can include logs of user transactions and other information related to interactions between users and the system 100.

In some embodiments, users can share user accounts included in user account data 136. For example, two or more users can share one user account in user account data 136. In one such embodiment, the one user account can be associated with a group (e.g., a financial institution) and can be accessed by one or more members of the group (e.g., one or more loan officers of the financial institution).

In some embodiments, users can purchase data (e.g., verified tax data) and/or services (e.g., cash flow computations) from the system 100. In such embodiments, user account data 136 can include account balances of the users. The account balances can include credits and/or debits associated with the user accounts, such as credits based on payments from users and debits based on purchases by users. Purchases can be made on an item-by-item basis. For example, in one such embodiment, a user can purchase a verified tax data file of a taxpayer based on providing a payment for the verified tax data file (e.g., twenty dollars per verified tax data file of a taxpayer). Alternatively and/or in combination, in some embodiments, data and/or services can be purchased on a subscription basis. For example, in one such embodiment, a user can purchase a subscription that allows the user to obtain an unlimited amount of data and/or services during a time period for a flat price (e.g., ten dollars for a one-month subscription). In some embodiments, users can be offered a subscription based on their association with one or more group accounts in user account data 136 (e.g., the previously described group accounts for a financial institution).

Verified tax data 138 includes one or more verified tax data files. As used herein, a data file can be understood to include a file having types and formats of data known to those of ordinary skill in the art. In some embodiments, a data file can be understood to include one or more portions of a data file. For example, in some embodiments, a data file can be understood to include data objects within a data file, such as attachments, records, and data rows and tables (e.g., data rows and tables in a structured query language (SQL) database file), with such examples being provided for illustration and not limitation.

Each verified tax data file in verified tax data 138 includes verified tax data of a taxpayer and is associated with a taxpayer identifier identifying the taxpayer and one or more user identifiers identifying one or more respective users of the system 100 having access rights (e.g., read and/or write access rights) to the verified tax data file. A taxpayer can include an individual taxpayer (e.g., a taxpayer having a U.S. tax filing status of single or married filing separately), a joint taxpayer (e.g., a taxpayer having a U.S. tax filing status of married filing jointly), and a business taxpayer (i.e., a non-personal entity), such as a company (e.g., a limited liability company), a corporation (e.g., a C or an S corporation), a partnership, a sole proprietorship, etc., with such examples being provided for illustration and not limitation. A taxpayer identifier can include an alphanumeric identifier. For example, a taxpayer identifier can include an identifier assigned or otherwise provided to a taxpayer by a federal and/or a state governmental entity, e.g., a U.S. Social Security Number (SSN), a U.S. Taxpayer Identification Number (TIN), and a U.S. Employer Identification Number (EIN). In some embodiments, a taxpayer identifier can be generated by the system 100 based on applying one or more data compression and/or data encryption schemes to data identifying the taxpayer. For example, a taxpayer identifier can include a compressed and/or encrypted taxpayer SSN. Alternatively and/or in combination, a taxpayer identifier can be selected or otherwise provided by a user of the system 100, e.g., a user who requests verified tax data of a taxpayer. A verified tax data file of a joint taxpayer can be associated with one or both of the taxpayer identifiers of the individual taxpayers included in the joint taxpayer. For example, a verified tax data file of a joint taxpayer can be associated with a taxpayer identifier for a husband and/or a taxpayer identifier for a wife. Alternatively, a verified tax data file of a joint taxpayer can be associated with a taxpayer identifier that is different than the taxpayer identifiers of the individual taxpayers included in the joint taxpayer.

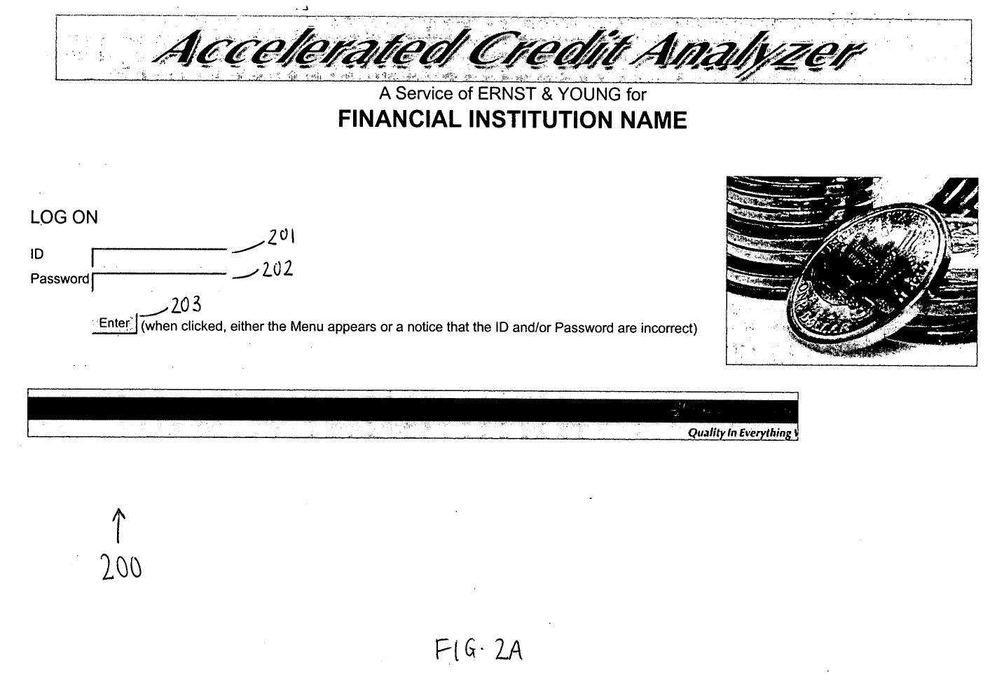

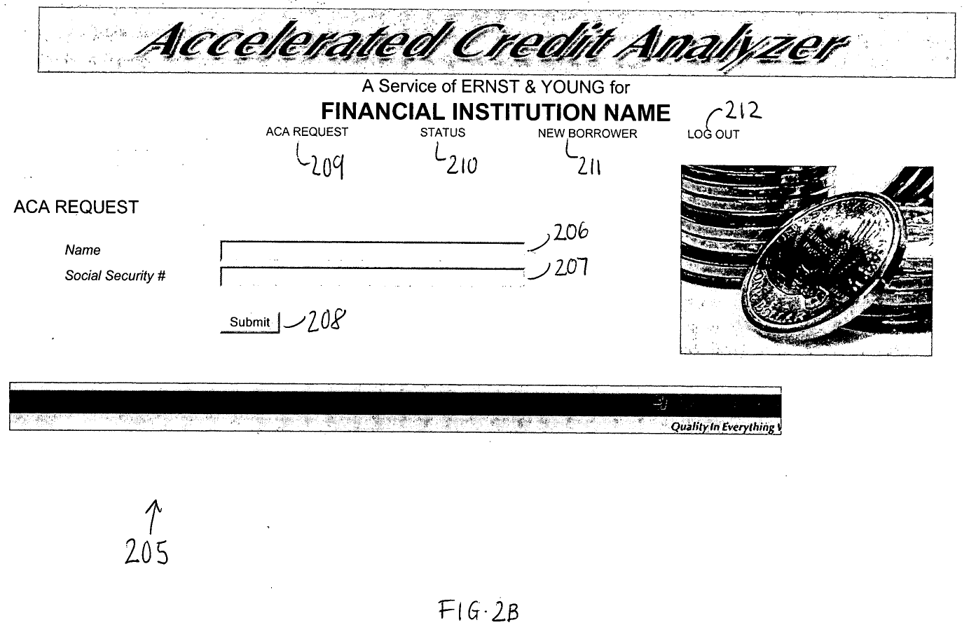

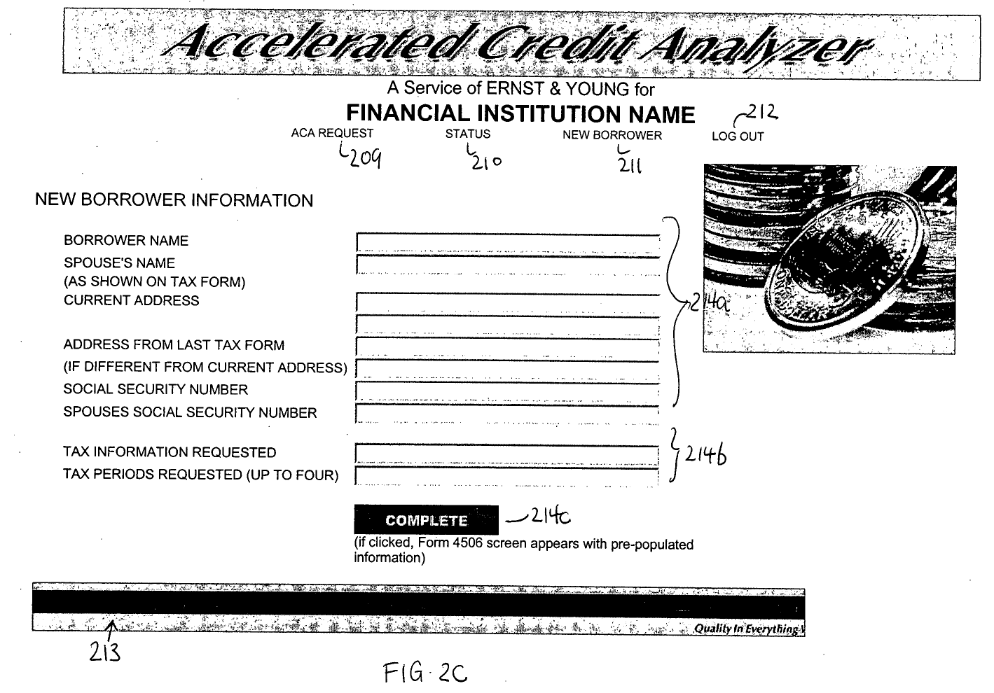

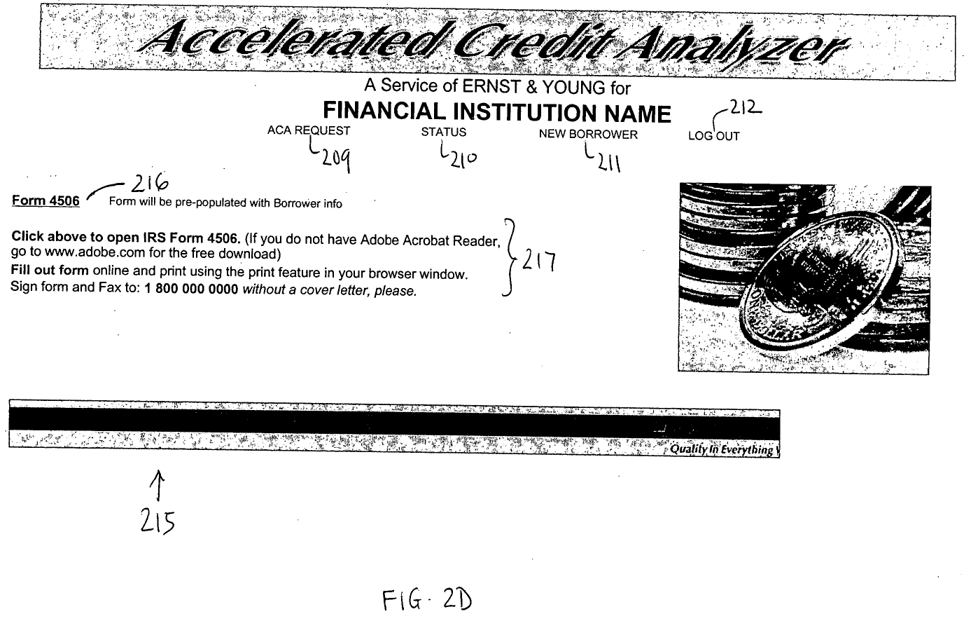

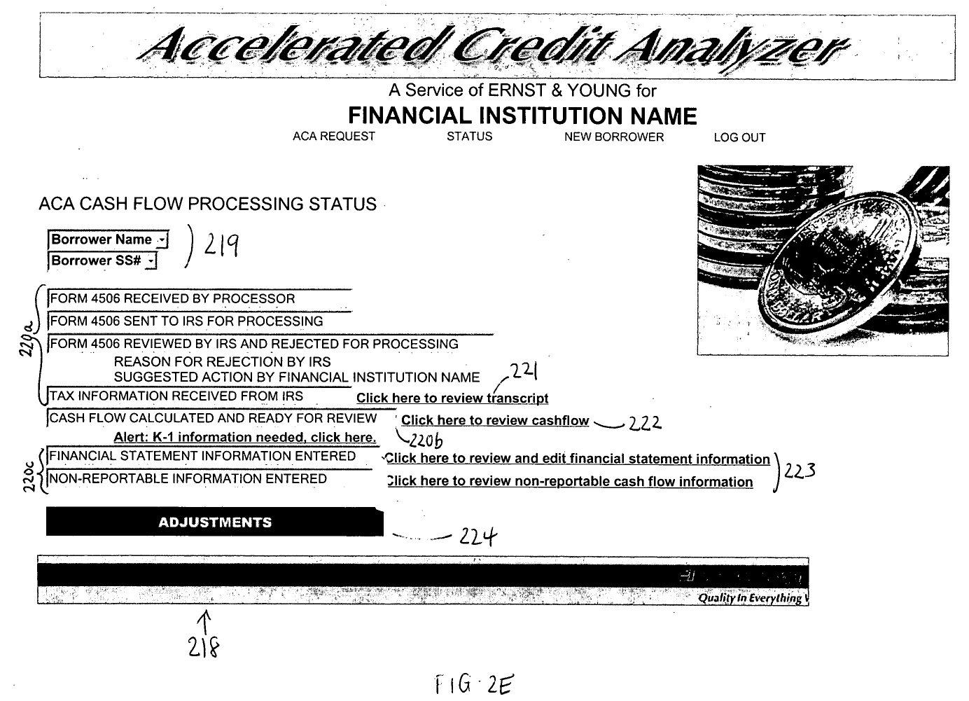

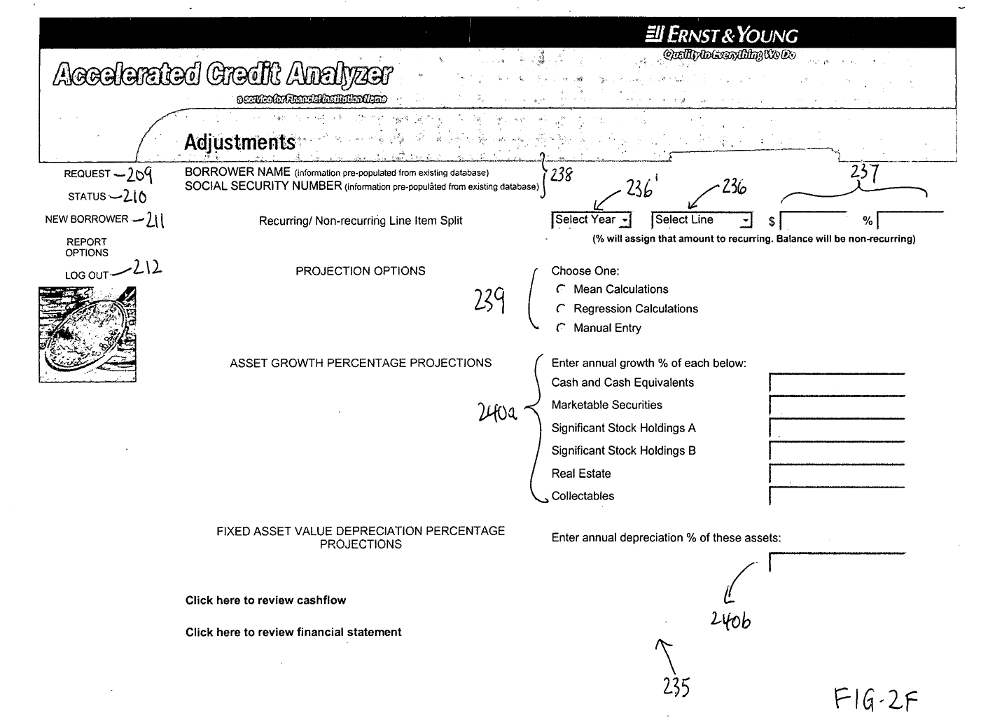

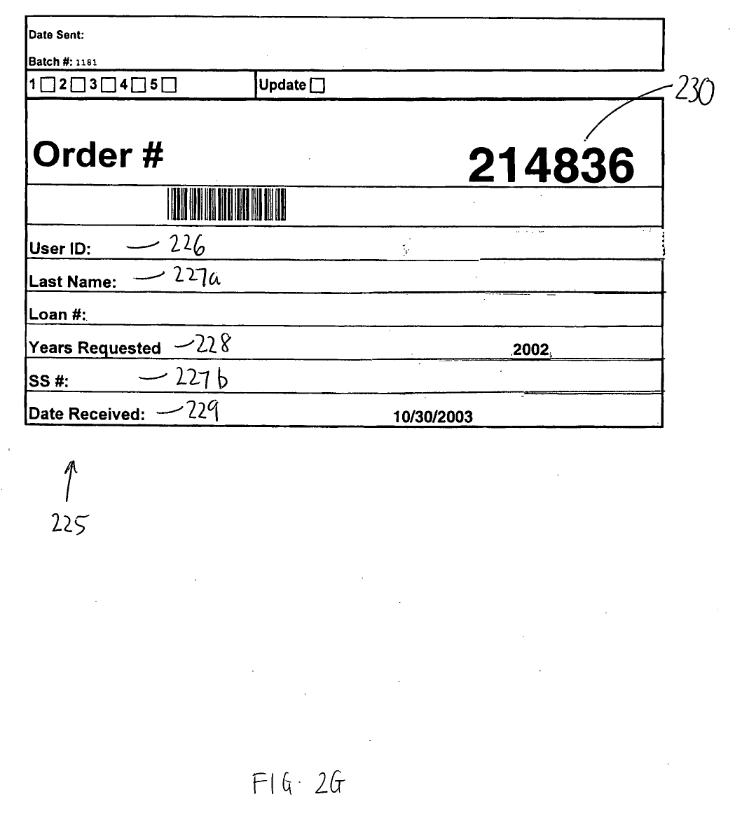

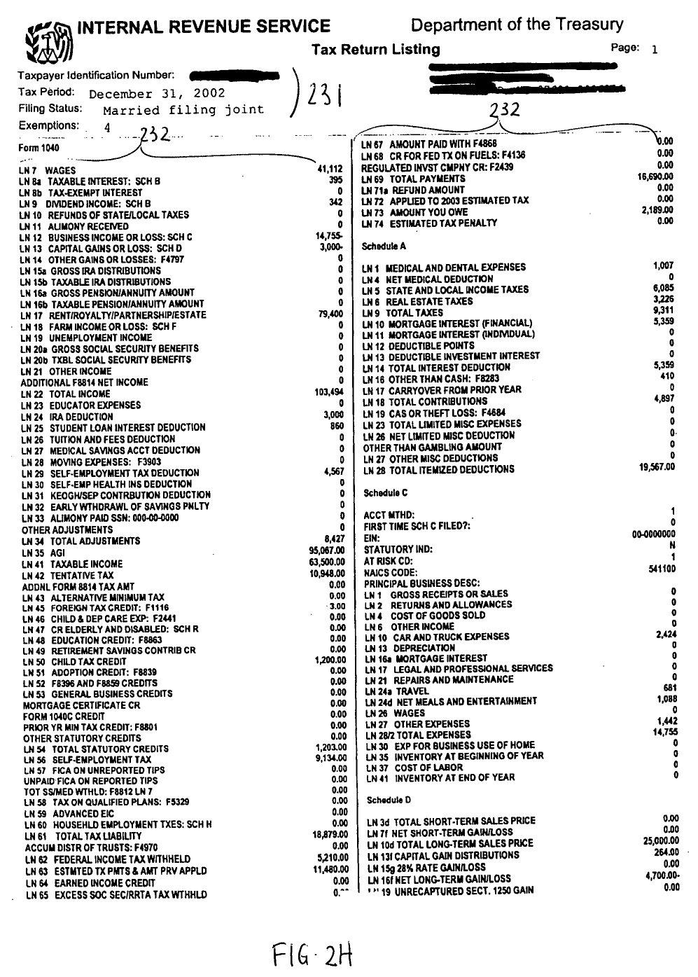

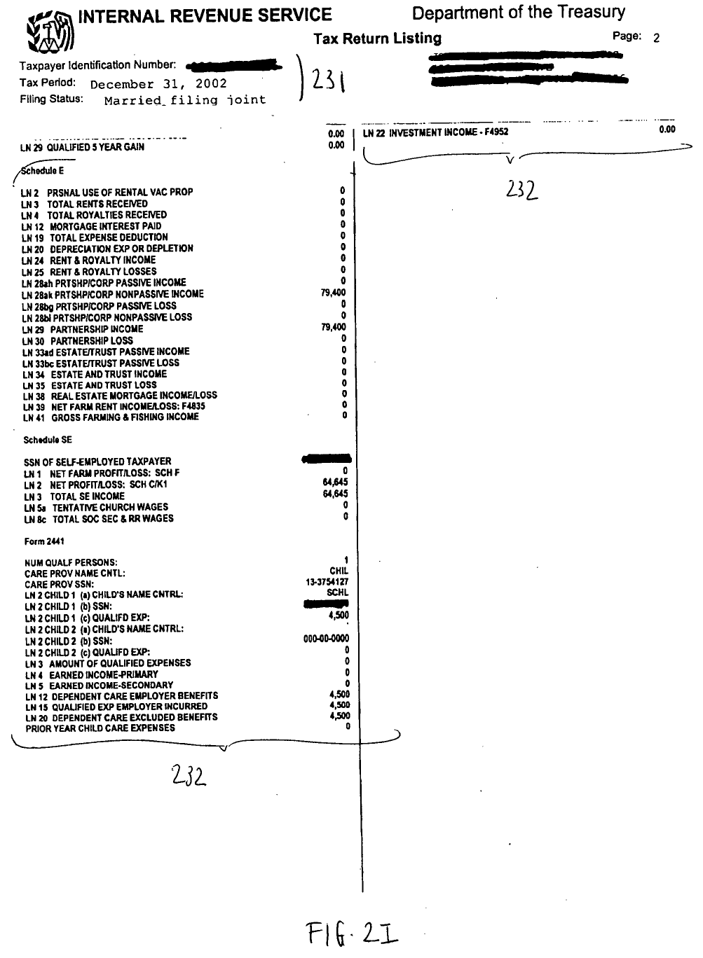

Generally, the verified tax data included in each verified tax data file includes data filed by a taxpayer with one or more governmental tax collection entities (e.g., a federal and/or a state tax collection entity, such as the U.S. Internal Revenue Service (IRS) and the Massachusetts Department of Revenue) and obtained directly and/or indirectly from the one or more governmental tax collection entities. In some embodiments, the verified tax data can also include data generated by a governmental tax collection entity based on the data filed by the taxpayer, such as tax audit and/or tax review data. The verified tax data can be obtained directly from a governmental tax collection entity (e.g., in one or more interactions with the governmental tax collection entity) and/or indirectly from the governmental tax collection entity (e.g., in one or more interactions with one or more intermediate entities, at least one of which directly obtained the verified tax data from the governmental tax collection entity). The verified tax data is based on one or more data elements (e.g., line items) of one or more tax forms filed by the taxpayer with a governmental tax collection entity. The tax forms include tax forms and/or tax schedules known to those of ordinary skill in the art, such as, but not limited to, IRS Forms 1040, 1041, 1065, 1120, 1120S, and W-2 and accompanying IRS Schedules A, B, C, D, E, and K-1. More specifically, the verified tax data is based on one or more data elements of one or more verified tax transcripts that are generated by the governmental tax collection entity based on the tax forms filed by the taxpayer with the governmental tax collection entity. (An illustrative and non-limiting example of a verified tax transcript is shown in FIGS. 2G-2I.) The verified tax data can be based on data provided by a governmental tax collection entity in reply to a request for verified tax data. For example, the verified tax data can be based on data provided by the IRS in reply to a request including an IRS Form 4506, an IRS Form 8821, and/or another similar IRS form either executed by a taxpayer or otherwise including an authorization from the taxpayer to release verified tax data. (As used herein, the term “similar IRS form” includes, but is not limited to, forms that are chronological updates to IRS Forms 4506 and 8821, such as IRS Form 4506-T.) In one illustrative and non-limiting example, a verified tax data file of a taxpayer can include gross income data based on an IRS Form 1040 filed by an individual taxpayer with the IRS (i.e., gross income data based on a verified tax transcript generated by the IRS based on the filed IRS Form 1040) and tax audit data generated by the IRS based on the IRS Form 1040.

Financial data 140 includes one or more financial data files. Each financial data file includes financial data of a taxpayer and is associated with a taxpayer identifier identifying the taxpayer and one or more user identifiers identifying one or more respective users having access rights (e.g., read and/or write access rights) to the financial data file.

Generally, the financial data of a taxpayer includes data other than verified tax data that relates to a cash flow of the taxpayer. For example, the financial data of a taxpayer can include data relating to incomes (e.g., inheritances, gifts received, life insurance proceeds, loan proceeds), expenses (e.g., gifts made, fixed and variable living expenses, and loan repayments), assets (e.g., liquid assets (such as cash, cash equivalents, and marketable securities) and non-liquid assets (such as personal property and real property)) and other items related to cash flow as understood by those of ordinary skill in the art. As described herein, some of the financial data can be based on data provided by a user of the system 100 and can be verified.

Request data 142 includes data based on one or more requests (e.g., request 148) provided by one or more users of the system 100. The requests can include requests for verified tax data of one or more taxpayers and requests for computing cash flows of one or more taxpayers. The stored requests can be associated with taxpayer identifiers (e.g., SSNs), user identifiers (e.g., usernames), alphanumeric tracking identifiers, status data (e.g., data indicating the status of the request, such as pending or completed, etc.), and time data (e.g., time of receipt, time of status, etc.).

Computation rules 144 include rules for computing a cash flow of a taxpayer. The computation rules 144 can be applied to verified tax data 138 and, in some embodiments, financial data 140 of a taxpayer to compute a cash flow. As used herein, the term “cash flow” refers to an availability of cash based on incomes and expenses and includes the understanding of one of ordinary skill in the art. In some embodiments, a cash flow can include a net cash flow for a time period, e.g., a monthly cash flow. Generally, the computation rules 144 can include rules for computing one or more cash inflows (e.g., incomes) for a time period, rules for computing one or more cash outflows (e.g., expenses) for the time period, and rules for computing a net cash flow for the time period based on the one or more computed inflows and outflows.

In some embodiments, the computation rules can include rules for computing a cash flow based on a net reportable cash flow and a net non-reportable cash flow. In some of such embodiments, the net reportable cash flow can be computed based on a measure of the difference between a reportable cash inflow and a reportable cash outflow. The reportable cash flow can be computed based on labor income (e.g., wages, salaries, and tips, etc/), interest income, dividend income, alimony, business income, rental income, farm income, installment sale income, etc. The reportable cash outflow can be computed based on expenses (e.g., tax-deductible or reportable and non-tax-deductible expenses) and reportable investments. Similarly, in some of such embodiments, the net non-reportable cash flow can be computed based on a measure of the difference between a non-reportable cash inflow and a non-reportable cash outflow. The non-reportable cash inflow can be computed based on proceeds from borrowing, inheritances, trust distributions, estate distributions, gifts, bond refundings, etc. As used herein, the term “measure of the difference” includes a difference, a difference of squares, a square root of a difference of squares, and other measures of difference known by those of ordinary skill in the art.

In some embodiments, the computation rules 144 can include rules for computing reportable expenses based on one or more of educator expenses, investment retirement account deductions, student loan interest deductions, tuition and fees deductions, moving expenses, self-employed pension contributions, alimony paid, medical and dental expenses, state and local income taxes, real estate taxes, personal property taxes, other taxes, home mortgage interest and points, gifts to charity, unreimbursed employee expenses, tax preparation fees, child and dependent care expenses, and interest expense on investment debts, as these terms are understood by those of ordinary skill in the art.

In some embodiments, the computation rules 144 can be based on cash flow computation models and/or rules of one or more governmental and/or quasi-governmental entities, such as the Federal National Mortgage Association (commonly known as Fannie Mae). In some of such embodiments, the computation rules 144 can be updated based on changes in relevant laws and regulations, such as changes in federal and/or state tax law regarding income tax rates, extent to which one or more expenses are deductible, etc.

The computation rules 144 can include one or more default rules for treating one or more recurring and/or non-recurring cash flow items. For example, the default rules can relate to the computation treatment of non-recurring incomes and expenses.

Option data 146 includes one or more option data files. Each option data file is associated with a user identifier identifying a user of the system 100 and includes options selected or otherwise provided by the user for treating non-recurring cash flow items. For example, the options can relate to the computation treatment of non-recurring incomes and expenses.

In some embodiments, the computation rules 144 and/or the options 146 can be selected and/or otherwise provided by a user of the system 100. For example, as previously described, two or more members of a group, such as a financial institution, can share one user account. In one such embodiment, one member of the group (such as a manager of the group) can provide the computation rules 144 and the options 146 to be used by all members of the group. Such an embodiment can reduce subjectivity in cash flow computations among group members.

Computation data 152 includes data based on parameters computed by the server 110 (e.g., one or more software application programs 108 residing on server 110). As described herein, the disclosed systems and methods can compute cash flows and/or other parameters related to cash flow (e.g., cash coverage ratios, debt payment coverage ratios, leverage ratios, future, i.e., projected cash flows, etc.). The server 110 can store the computed parameters in computation data 152 and associate the stored parameters with user identifiers and taxpayer identifiers.

As previously described, the disclosed systems and methods can compute a cash flow of a taxpayer based on a request from a user of system 100 shown in FIG. 1. Illustrative displays of graphical user interfaces that facilitate computations of cash flows are shown in FIGS. 2A-2I. The illustrative displays can include one or more check boxes, one or more response boxes, one or more radio buttons, one or more pull-down menus, one or more icons, and/or one or more other visual objects to facilitate the computation of the cash flow. Those of ordinary skill in the art will understand that the illustrative displays are to be interpreted in an exemplary manner and that displays different than those shown and described herein can be used within the scope of the present disclosure. For example, features of the illustrative displays can be combined, separated, interchanged, and/or rearranged to generate other displays. As will be understood by those of ordinary skill in the art, the illustrative displays can be provided by a server (e.g., a software application program residing on a server) to a client (e.g., a software application program residing on a client) in system 100. The illustrative displays are described in the context of interactions (e.g., requests and responses) between client 106 and server 110 in system 100.

FIG. 2A shows an exemplary login window 200 that provides access to a website hosted by the server 110. As shown in FIG. 2A, the login window 200 includes query boxes 201 and 202 for providing a username (labeled ID in FIG. 2A) and a password for accessing the website and an entry icon 203 for submitting the username and password to the website.

FIG. 2B shows an exemplary request window 205 for requesting verified tax data and/or cash flow computations for a taxpayer. As shown in FIG. 2B, the request window 205 includes query boxes 206 and 207 for providing information relating to the identity of the taxpayer, such as a taxpayer name and an SSN, and an entry icon 208 for submitting the information to the website. As also shown in FIG. 2B, the request window 205 includes links, i.e., hyperlinks, for navigating to one or more other windows in the website. For example, the request window 205 includes a link 209 to the request window 205, a link 210 to a status window, a link 211 to a new borrower/taxpayer window, and a link 212 to a logout window.

FIG. 2C shows an exemplary new borrower/taxpayer window 213 for providing information relating to a borrower/taxpayer. The new borrower/taxpayer window 213 can be displayed based on the server 110 not finding stored requests and/or verified tax data files associated with the taxpayer identity provided in the request window 205. As shown in FIG. 2C, the window 213 can include query boxes 214a for providing information relating to the borrower/taxpayer, such as the name, address, and SSN of the borrower/taxpayer, query boxes 214b for providing information relating to a request, such as requested tax years and requested tax information on which to compute a cash flow, and an entry icon 214c for submitting the information to the website.

FIG. 2D shows an exemplary form generation window 215 for generating an authorization form to be executed by the borrower/taxpayer. The form generation window 215 includes a form generation icon 216 for generating the form, e.g., an IRS Form 4506. In some embodiments, the server 110 can pre-populate and/or otherwise include data in one or more corresponding fields of the form to facilitate completion of the form. The form generation window 215 also includes instructions 217 for generating and completing the form.

FIG. 2E shows an exemplary status window 218 that can be displayed based on the server 110 receiving a selection of link 210, finding one or more stored requests associated with the taxpayer identity provided in the request window 205, and/or finding one or more verified tax data files associated with the taxpayer identity. As shown in FIG. 2E, the status window 218 includes taxpayer data 219 that identifies a taxpayer associated with a request, e.g., a request for verified tax data. As also shown in FIG. 2E, the status window 218 includes status data 220a identifying the processing status of a request for verified tax data, status data 220b identifying the processing status of a request for cash flow computation, and status data 220c indicating whether the databases 134 include financial data associated with the taxpayer. The status window 218 also includes a link 221 to a verified tax transcript, a link 222 to a cash flow computation, links 223 to financial data, and an adjustment icon 224 for navigating to an adjustment window 235.

FIG. 2F shows an exemplary adjustment window 235 for providing one or more options for (i) treating recurring and/or non-recurring items in a cash flow computation and/or (ii) computing pro-form a projections, e.g., projected pro-form a incomes, projected pro-form a expenses, and/or projected pro-form a cash flows. The adjustment window 235 can be displayed based on the server 110 receiving a selection of the adjustment icon 224 in the status window 218 of FIG. 2E. As shown in FIG. 2F, the adjustment window 235 includes a taxpayer identification portion 238, a pull-down menu 236′ for selecting a year of a verified tax transcript, a pull-down menu 236 for selecting a line item from the selected verified tax transcript to be split between recurring and non-recurring portions, and an accompanying response box 237 for providing data representing the ratio of the split. As also shown in FIG. 2F, the adjustment window 235 includes one or more radio buttons 239 for selecting a projection technique, one or more response boxes 240a for providing projections of asset growth, and one or more response boxes 240b for providing projections of asset depreciation.

FIGS. 2G-2I show an exemplary verified tax transcript that can be displayed based on the server 110 receiving a selection of the link 221 in the status window 218. As will be understood by those of ordinary skill in the art, verified tax transcripts can include organizations and/or types of information that are different than and/or additional to that shown in FIGS. 2G and 2I. The shown transcript is an example of a verified tax transcript that was obtained from the IRS via a vendor of verified tax data. As shown in FIG. 2G, the verified tax transcript includes a request summary 225 that identifies the user 226 who requested the verified tax data, the name 227a and SSN 227b of the taxpayer for whom the user 226 requested the verified tax data, the one or more tax periods 228 of the request, the date 229 of the request, and an alphanumeric tracking identifier 230 associated with the user's request. As shown in FIGS. 2H and 2I, the transcript includes one or more printed pages of verified tax data, in which each page includes an identification portion 231 that identifies the taxpayer and the tax period of the transcript and one or more line items 232 that include data from one or more tax forms submitted by the taxpayer to the IRS. For example, as shown in FIGS. 2H and 2I, the line items 232 include data from IRS Form 1040, IRS Schedules A, C, D, E, SE, and IRS Form 2441.

In one illustrative operation and with reference to FIG. 1, the software application program executing within the memory 118 of the client 106 can detect a request 148 to compute a cash flow of a taxpayer from the user 102 by, for example, receiving an indication from the I/O subsystem 124 that detected a mouse click, a keyboard entry, and/or another input event initiated by the user 102 (e.g., an entry received with respect to windows 205, 213 of FIGS. 2B and 2C). In response to the request 148, the software application program 104 instruct the graphics subsystem 122 (via the processor 114) to display one or more options for selection by the user and/or one or more requests for information from the user. The user 102 can then initiate another input event corresponding to, for example, an entry of a taxpayer identifier. Similar sequences of input events and detections by the software application program 104 can enable the user 102 to specify one or more additional parameters that define a cash flow computation request of interest, which can include one or more of a taxpayer identifier, a time period of data based on which to compute the cash flow (e.g., one or more years of data), and one or more options for treating recurring and/or non-recurring items. The request 148 and its associated parameters selected by the user 102 can be maintained in the memory 118 of the client 106 prior to transmission to the server 110 via the network 112. The software application program 104 can apply one or more rules to the request 148 to reduce the occurrence of erroneous requests. One or more of these rules can be contained in memory 118. Alternatively and/or in combination, the software application program 104 can access one or more of these rules from the database 134 via the network 112. As will be understood by those of ordinary skill in the art, in one embodiment, the software application program 104 can apply one or more data validation rules to the request 148 to determine the validity of the parameters associated with the request 148 and notify the user 102 of errors.

With continuing reference to FIG. 1, the software application program 104 can instruct the network connection process 128 of the client 106 to transmit the parameters associated with the request 148 selected by the user 102 to a calculation process or another software process associated with the software application program 108 executing on the server 110 by, for example, encoding, encrypting, and/or compressing the selected request 148 into a stream of data packets that can be transmitted between the networking subsystems 120 of the digital data processing devices 106, 110. The network connection process 130 executing on the server 110 can receive, decompress, decrypt, and/or decode the information contained in the data packets and can store such elements in a memory accessible to the software application program 108. The software application program 108 can process the request 148 by, for example, applying one or more computation rules 144 and options 146 to verified tax data 138 and financial data 140 of a taxpayer.

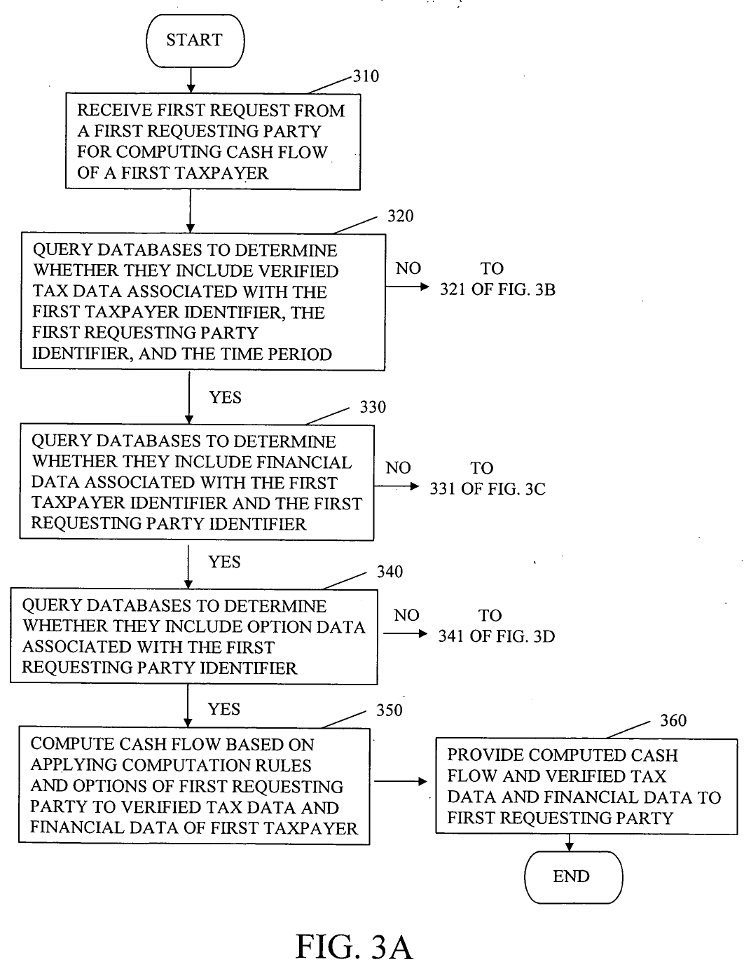

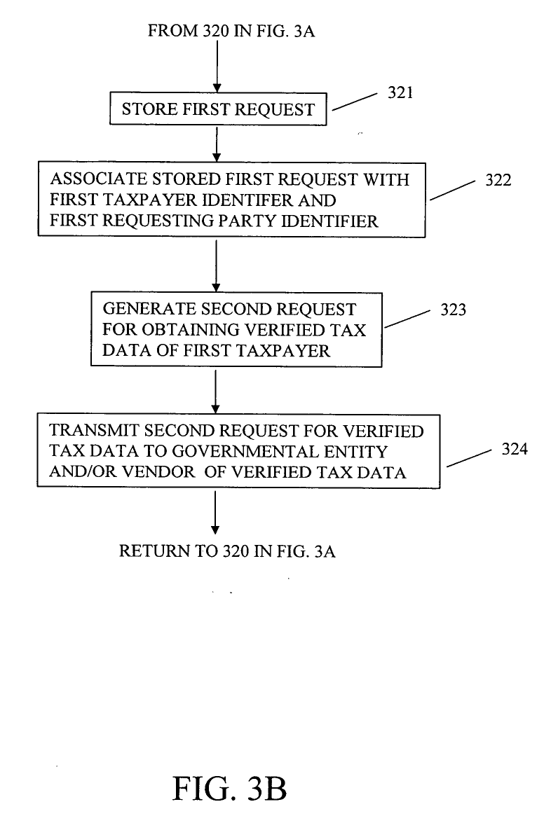

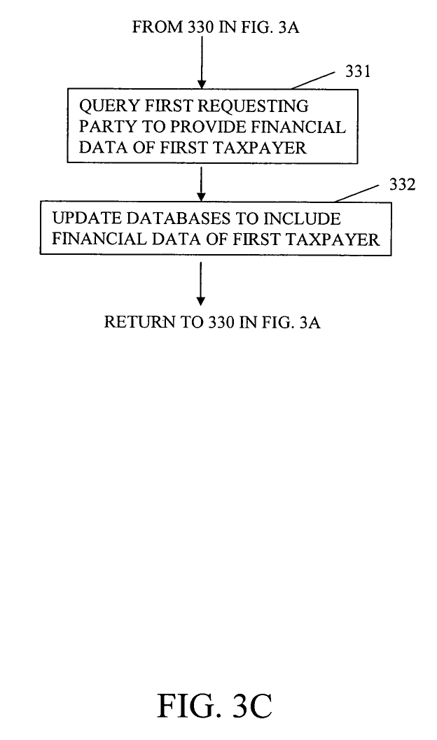

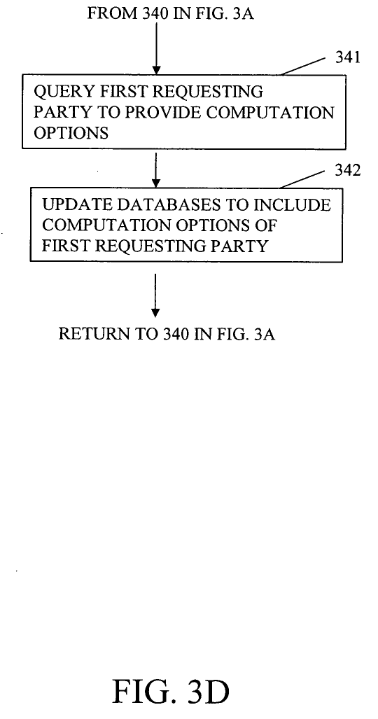

FIGS. 3A-3D schematically illustrate an embodiment of a method for computing a cash flow of a taxpayer based on a request from a user of system 100. As will be understood by those of ordinary skill in the art, the disclosed systems and methods are not limited to the embodiment shown in FIGS. 3A-3D and can compute one or more cash flows of one or more taxpayers based on one or more flow elements different than and/or additional to those shown in FIGS. 3A-3D.

As shown in FIG. 3A, a first request (e.g., request 148) from a user 102 (“first requesting party”) interacting with a client (e.g., client 106) for computing a cash flow of a first taxpayer is received at a server (e.g., server 110) in system 100 (310 in FIG. 3A). The request includes data identifying the first taxpayer (e.g., a first taxpayer identifier) and a time period of data based on which to compute the cash flow (e.g., one or more years of verified tax data and, in some embodiments, financial data).

Based on the first request, the server 110 (e.g., a software application program 108 residing on server 110) queries the one or more databases 134 to determine whether they include verified tax data associated with the first taxpayer identifier, a user identifier corresponding to the first requesting party, and the time period (320 in FIG. 3A). For example, in one embodiment, the server 110 queries verified tax data 138 to find one or more verified tax data files associated with the SSN, TIN, or EIN of the first taxpayer, the username of the first requesting party, and tax data for one or more years, e.g., tax years 2001 and 2002.

Based on not finding verified tax data for the first taxpayer (i.e., based on not finding verified tax data files associated with the first taxpayer identifier, the first requesting party identifier, and the time period), the server 110 proceeds to flow element 321 of FIG. 3B to obtain the verified tax data.

Based on finding the verified tax data for the first taxpayer, the server 110 queries financial data 140 to find financial data files associated with the first taxpayer identifier, the first requesting party identifier, and the time period (330 in FIG. 3A). Alternatively, in some embodiments, based on finding the verified tax data for the first taxpayer, the server 110 proceeds directly to flow element 340 (determining options of the first requesting party for treating subjective cash flow computation items) and/or flow element 350 (computing the cash flow based on the verified tax data of the first taxpayer).

Based on not finding financial data for the first taxpayer (i.e., based on not finding financial data files associated with the first taxpayer identifier, the first requesting party identifier, and the time period), the server 110 proceeds to flow element 331 of FIG. 3C to obtain the financial data.

Based on finding the financial data for the first taxpayer, the server 110 queries option data 146 to find option data files associated with the first requesting party (340 in FIG. 3A). Alternatively, in some embodiments, based on finding the financial data, the server proceeds directly to flow element 350 (computing the cash flow based on default computation rules for treating subjective cash flow computation items).

Based on not finding option data associated with the first requesting party, the server 110 proceeds to flow element 341 of FIG. 3D to obtain the option data.

With continuing reference to FIG. 3A, the server 110 can compute the cash flow of the first taxpayer based on applying the computation rules 144 and the options 146 of the first requesting party to the verified tax data 138 and the financial data 140 of the first taxpayer (350 in FIG. 3A). The server 110 can compute the cash flow based on schemes known to those of ordinary skill in the art.

As will be understood by those of ordinary skill in the art, the disclosed systems and methods are not limited to computing cash flows based on applying computation rules 144 and options 146 to verified tax data 138 and financial data 140 of a taxpayer. For example, in some embodiments, the disclosed systems and methods can compute cash flows based on applying computation rules 144 to verified tax data 138 and/or financial data 140. In such embodiments, the computation rules 144 can include default rules for treating non-recurring cash flow items (e.g., non-recurring incomes and/or expenses).

As shown in FIG. 3A, the server 110 provides the computed cash flow of the first taxpayer to the first requesting party (360 in FIG. 3). The server 110 can provide the cash flow in a format selected by a user of system 100, such as a spread format, a condensed format, and a tax return format, as these terms are understood by those of ordinary skill in the art. In some embodiments, the server 110 can provide the cash flow in the form of a single recurring cash flow number. The server 110 can transmit the computed cash flow to the client 106 based on schemes known to those of ordinary skill in the art, such as, but not limited to, email, download, facsimile, regular (i.e., non-electronic) postal mail, etc. In some embodiments, the server 110 can post the computed cash flow (and other data, such as verified tax data) to a secure (i.e., password protected) website and email a hyperlink to the website to the client 106.

As also shown in FIG. 3A, in some embodiments, the server 110 can provide the verified tax data and/or the financial data of the first taxpayer to the first requesting party. The server 110 can provide the verified tax data in the form of one or more electronic data files, such as one or more electronic verified tax data files. Alternatively and/or in combination, in some embodiments, the server 110 can provide the verified tax data in the form of an electronic transcript, such as the electronic transcript received from a vendor of verified tax data. In some of such embodiments, the server 110 can provide the electronic transcript in a format selected by a user of the system 100, e.g., Portable Document Format (PDF). (An illustrative and non-limiting example of a verified tax transcript is shown in FIGS. 2G-2I.)

As previously described, the server 110 can determine at 320 in FIG. 3A that verified tax data 138 does not include verified tax data files associated with the first taxpayer identifier, the first requesting party identifier, and the time period. Such a scenario can occur as a result of the first request from the first requesting party being a new (i.e., not previously received) request.

As shown in FIG. 3B, based on determining that verified tax data 138 does not include such verified tax data files, the server 110 stores the first request 148 for the verified tax data in request data 142 (321 in FIG. 3B) and associates the stored first request with the first taxpayer identifier, the first requesting party identifier, and, in some embodiments, an alphanumeric tracking identifier (322 in FIG. 3B). The alphanumeric tracking identifier can be selected and/or otherwise provided by the first requesting party and/or the server 110. In some embodiments, the server 110 associates the stored first request with time data (e.g., time of receipt) and status data (e.g., data indicating the status of the request, such as or completed, etc.).

As will be understood by those of ordinary skill in the art, a first entity can request verified tax data of a second entity from a governmental tax collection entity based on providing the governmental tax collection entity with an authorization from the second entity to release the verified tax data to the first entity. For example, an underwriter can request verified tax data of a borrower from the IRS based on providing the IRS with an authorization form executed by the borrower. The authorization form can include an IRS Form 4506, an IRS Form 8821, and/or other similar IRS forms.

With continuing reference to FIG. 3B, the server 110 generates a second request for obtaining the verified tax data of the first taxpayer from one or more governmental tax collection entities and/or one or more vendors of verified tax data (323 in FIG. 3B). The second request includes data that identifies the first taxpayer, data that identifies the time period of interest, i.e., the time period of the first request (e.g., tax years 2001 and 2002), data that authorizes the governmental tax collection entity to release the verified tax data of the first taxpayer, and, in some embodiments, the alphanumeric tracking identifier associated with the first request. As will be understood by those of ordinary skill in the art, in some embodiments, the second request can be associated with time data (e.g., a time of generating the request) and/or status data (e.g., data indicating a status of the request, such as pending or completed, etc.). In some embodiments, the server 110 can transmit a template or blank authorization form to the client 106 for completion by the first requesting party and the first taxpayer. The server 110 can provide data in one or more corresponding fields of the form prior to transmission to the client 106 to facilitate completion of the form. For example, the server 110 can provide the first taxpayer identifier in a field for the taxpayer identifier, etc. The client 106 (i.e., the first requesting party) can provide the executed authorization form to the server 110 via, for example, facsimile transmission. The server 110 transmits the second request to a governmental tax collection entity and/or one or more vendors of verified tax data, at least one of whom interacts with the governmental tax collection entity (324 in FIG. 3B). In some embodiments, the server 110 stores the second request in request data 142 and associates the stored second request with the first taxpayer identifier, the first requesting party identifier, and the alphanumeric tracking identifier associated with the first request.

Based on transmitting the second request, the server 110 returns to 320 in FIG. 3A, i.e., returns to querying the databases 134 for verified tax data of the first taxpayer. For example, the server 110 can return to querying the databases 134 based on one or more updates to the databases 134, as described herein.

In some embodiments, the server 110 can determine at 320 in FIG. 3A that verified tax data 138 includes one or more verified tax data files associated with the first taxpayer identifier and the time period, but that such verified tax data files are not associated with the first requesting party identifier. Such a scenario can occur as a result of one or more requesting parties other than the first requesting party having previously requested the verified tax data of the first taxpayer.

As an alternative to and/or in combination with the embodiment shown and described in FIG. 3B, in some of such embodiments, the server 110 can request that the first requesting party provide an authorization from the first taxpayer for the release of the verified tax data (e.g., an authorization in the form of an executed IRS Form 4506 or IRS Form 8821). Based on receiving the authorization, the server 110 can update the databases 134 to associate the verified tax data files of the first taxpayer with the first requesting party identifier and return to 320 in FIG. 3A, i.e., return to querying the databases 134 for verified tax data of the first taxpayer.

As previously described, the server 110 can determine at 330 in FIG. 3A that financial data 140 does not include financial data files associated with the first taxpayer identifier, the first requesting party identifier, and the time period. As shown in FIG. 3C, based on determining that financial data 140 does not include such financial data files, the server 110 queries the client 106 (i.e., the first requesting party via the client 106) to provide the financial data of the first taxpayer (331 in FIG. 3C). In some embodiments, the server 110 can query the first requesting party to provide one or more cash flow items, such as values of one or more incomes (e.g., inheritances, gifts received, life insurance proceeds, loan proceeds), values of one or more expenses (e.g., gifts made, fixed and variable living expenses, and loan repayments), and values of one or more assets (e.g., liquid assets (such as cash, cash equivalents, and marketable securities) and non-liquid assets (such as personal property and real property)) of the first taxpayer. Based on receiving financial data of the first taxpayer, the server 110 can update the databases 134 to include the financial data, associate the financial data with the first taxpayer identifier and the first requesting party identifier, and return to 330 in FIG. 3A, i.e., return to querying the databases 134 for financial data of the first taxpayer.

In some embodiments, the server 110 can communicate with one or more entities to verify one or more of the cash flow items included in financial data 140. For example, in one such embodiment, the server 110 can generate requests for one or more servers of one or more financial institutions (e.g., a bank, a brokerage, etc.) to provide data relating to securities holdings associated with the taxpayer. The requests can include an authorization from the taxpayer to release the data.

Similarly, in some embodiments, the server 110 can perform one or more internal consistency checks on one or more of the cash flow items included in financial data 140. For example, the server 110 can compute a net worth of a taxpayer based on the verified tax data 138 and/or the financial data 140 of the taxpayer and schemes known to those of ordinary skill in the art. For example, in some embodiments, the net worth can be computed based on a measure of the difference between total assets and total liabilities. In some of such embodiments, the total assets can include liquid invested assets (e.g., cash and cash equivalents (such as checking accounts, savings accounts, money market accounts, certificates of deposit, etc.) and invested assets (such as stocks, bonds, mutual funds, commodities, etc.), non-liquid invested assets (e.g., unlisted securities, partnership interests, business interests, farm interests, notes receivable, investment real estate, cash surrender value of life insurance, vested portions of pension plans, retirement accounts, collectables, etc.), and use assets (e.g., primary home, vacation homes, vehicles, equipment, personal property, etc.). Similarly, in some of such embodiments, the total liabilities can include current liabilities (e.g., credit cards, accounts and bills payable, notes payable, taxes payable, final installment payments, lines of credit, etc.), term liabilities (e.g., installment loans, primary home mortgages, vacation home mortgages, investment mortgages, term business loans, loans against life insurance, etc.), and contingent liabilities. In one such embodiment, the server 110 can compute a first net worth of a taxpayer at a first time (e.g., at year-end 2001) and a second net worth of the taxpayer at a second later time (e.g., at year-end 2002). Using verified tax data 138 for the tax year bounded by the years of the net worth computations and financial data 140, the server 110 can compute living expenses for the taxpayer. For example, the server 110 can compute living expenses based on one or measures of the difference between the first net worth and the second net worth. The server 110 can update the financial data 140 of the taxpayer to include the computed living expenses (which can be referred to as verified living expenses).

As previously described, the server 110 can determine at 340 in FIG. 3A that option data 146 does not include option data files associated with the first requesting party identifier. As shown in FIG. 3D, based on determining that option data 146 does not include such option data files, the server 110 can query the client 106 (i.e., the first requesting party via the client 106) to provide one or more options for treating subjective cash flow computation items (341 in FIG. 3C). For example, in some embodiments, the server 110 can query the first requesting party to provide options related to the treatment of recurring and/or non-recurring cash flow items. Also for example, in some embodiments, the server 110 can query the first requesting party to provide options related to treatment of data included in one or more K-1 forms. Alternatively and/or in combination, the server 110 can provide one or more selectable options to the first requesting party.

Based on receiving selected and/or provided options, the server 110 can update the databases 134 to include the options of the first requesting party, associate the options with the first requesting party identifier, and return to 340 in FIG. 3A, i.e., return to querying the databases 134 for option data of the first taxpayer.

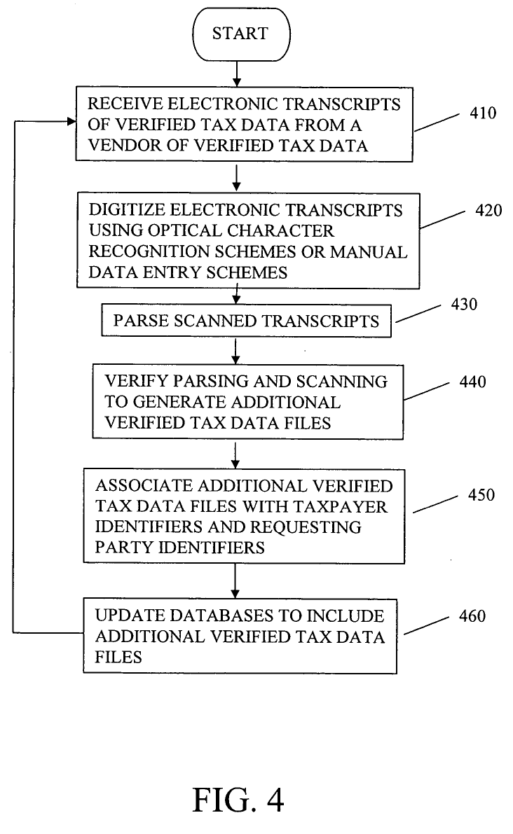

FIG. 4 schematically illustrates an embodiment of a method for updating verified tax data 138 of system 100. As will be understood by those of ordinary skill in the art, the disclosed systems and methods are not limited to the embodiments of FIG. 4 and can update the verified tax data 138 of system 100 based on flow elements different than and/or additional to those shown in FIG. 4.

As previously described, the server 110 can transmit at element 324 of FIG. 3B second requests for verified tax data to one or more governmental tax collection entities and/or one or more vendors of verified tax data. As shown in FIG. 4, in embodiments in which the server 110 transmits a second request to a vendor, the server 110 receives one or more electronic transcripts (i.e., electronic data files) that summarize the verified tax data of the first taxpayer. For example, the electronic transcripts can include data based on one or more data elements (e.g., line items) from one or more tax forms filed by the first taxpayer with the governmental tax collection entity (410 in FIG. 4). (As previously described, the transcripts can include verified tax transcripts generated by the governmental tax collection entity (e.g., the IRS) based on the tax forms filed by the taxpayer with the governmental tax collection entity. As will be understood by those of ordinary skill in the art, the IRS can, in some circumstances, provide verified copies of tax forms filed by taxpayers with the IRS, instead of or in addition to verified tax transcripts. As used herein, the term verified tax transcripts includes such verified copies.) In embodiments in which the server 110 transmits a second request to a governmental tax collection agency, the server 110 receives one or more non-electronic transcripts that summarize the verified tax data of the first taxpayer. (As will be understood by those of ordinary skill in the art, the IRS provides non-electronic transcripts similar to that shown in FIGS. 2G-2I. The disclosed systems are not limited, however, to receiving non-electronic transcripts from the IRS and/or other governmental tax collection entities, but can receive electronic and/or non-electronic transcripts from the IRS and/or other governmental tax collection entities. For example, the disclosed systems and methods can be configured to receive and otherwise process electronic transcripts in a markup language, e.g., a Standard Generalized Markup Language, such as, but not limited to, extensible markup language (XML) and hypertext markup language (HTML).) The server 110 can convert the non-electronic transcripts to electronic transcripts based on schemes known to those of ordinary skill in the art. The server 110 digitizes electronic transcripts by scanning the transcripts with optical character recognition schemes and/or manual data entry schemes (e.g., hand-keyed data entry schemes) (420 in FIG. 4), parsing the digitized transcripts into one or more pre-determined data fields (e.g., one or more income fields, such as a wages and salary field and a business income field, and one or more expense fields, such as a mortgage interest expense field and a charitable contribution field) (430 in FIG. 4), and verifying the digitizing (i.e., the scanning, the parsing, and/or the keyed input) for digitizing errors. Based on digitized electronic transcripts, the server 110 generates additional verified tax data files (440 in FIG. 4). The server 110 can verify the digitizing (i.e., the parsing, the scanning, and/or the keyed input) based on one or more automatic and/or manual verification schemes. In embodiments in which the server 110 associates stored first and/or second requests with alphanumeric tracking identifiers, the server 110 identifies stored requests that are associated with the same tracking identifiers as the additional verified tax data files and associates the additional verified tax data files with the taxpayer identifiers and the requesting party identifiers of the stored requests (450 in FIG. 4). In some embodiments, the server 110 can update the status data of the stored first and/or second requests associated with the alphanumeric tracking identifier. For example, the server 110 can update the status data to change the status from pending to completed. The server 110 updates the verified tax data 138 in the databases 134 to include the additional verified tax data files (460 in FIG. 4) and returns to receiving electronic transcripts from vendors (410 in FIG. 4). In some embodiments, the server 110 can transmit messages to or otherwise notify requesting parties of updates to the databases 134, i.e., updates to the databases 134 that include verified tax data requested by the requesting parties.

In some embodiments, the server 110 can coalesce, i.e., merge, one or more verified tax data files. For example, in some embodiments, the server 110 can merge verified tax data files associated with the same taxpayer identifier and different requesting party identifiers into a single verified tax data file having portions associated with the different requesting party identifiers. Also for example, in some embodiments, the server 110 can merge verified tax data files associated with the same first taxpayer identifier and the same first requesting party identifier into a single verified tax data file.

As will be understood by those of ordinary skill in the art, the disclosed systems and methods are not limited to computing cash flows of taxpayers and can compute a variety of other parameters related to cash flow.

For example, in some embodiments, the disclosed systems and methods can compute one or more cash coverage ratios, one or more debt payment coverage ratios, and one or more leverage ratios for one or more taxpayers based on verified tax data 138 and/or financial data 140 and schemes known to those of ordinary skill in the art.

Also for example, in some embodiments, the disclosed systems and methods can compute estimates of one or more future cash flows (i.e., projected pro-form a cash flows) based on one or more of previous computed cash flows, previous verified tax data, previous financial data, previous computed averages, and one or more statistical schemes (e.g., averaging and/or regression schemes based on one or more years of data).

As will be understood by those of ordinary skill in the art, the disclosed systems and methods can be used by an underwriter as a factor in determining whether to grant a loan to a borrower. In some embodiments, the disclosed systems and methods can be used to evaluate policies by which users of the system 100 grant loans to borrowers.

As previously described, the server 110 can store computed cash flows and/or other computed parameters in computation data 152 and associate the stored computations with user identifiers and taxpayer identifiers.

In some embodiments, a user can provide the server 110 with information related to (i) amounts of loans granted by the user to borrowers (i.e., taxpayers) based on the computed cash flows of the borrowers and (ii) status of the loans (e.g., repayment status), and the server 110 can associate the stored computations of the user with the loan amounts and the loan statuses. In one such embodiment, the user can determine whether to grant a loan to a new borrower based on comparing the computed cash flow (and/or other computed parameters) of the new borrower with the computed cash flows of previous borrowers, the amounts of loans granted to those previous borrowers, and the statuses of the loans.

Alternatively and/or in combination, in some embodiments, the server 110 can provide the user with information related to the loan portfolios of other users. For example, in one such embodiment, the server 110 can provide the user with information based on (i) computed cash flows of borrowers, (ii) amounts of loans granted by the other users to the borrowers, and (iii) statuses of the loans. The server 110 can provide the information in an anonymous format, i.e., a format in which data identifying the other users and their borrowers are removed and/or otherwise hidden. In one such embodiment, the user can determine whether to grant a loan to a new borrower based on the loan portfolios of other users.

In some embodiments, the server 110 can extract “global” information from the databases 134, i.e., information related to multiple users. For example, in one such embodiment, the server 110 can compute global averages, such as global averages of loan performance, either inside and/or outside the user's employer.

In some embodiments, the server 110 can monitor the user portfolios in the databases 134 for compliance with laws and regulations related to lending, such as federal and/or state fair credit and fair lending laws.

Accordingly, systems and methods for computing cash flows are described herein. The disclosed systems and methods can provide improved accuracy, consistency, and predictability in cash flow computations because they can apply computation rules that are uniform among underwriters to verified data.

The systems and methods described herein are not limited to a hardware or software configuration; they can find applicability in many computing or processing environments. The systems and methods can be implemented in hardware or software, or in a combination of hardware and software. The systems and methods can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted. The computer programs can be stored on a storage medium or a device (e.g., compact disk (CD), digital video disk (DVD), magnetic tape or disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein.

Unless otherwise provided, references herein to memory can include one or more processor-readable and -accessible memory elements and/or components that can be internal to a processor-controlled device, external to a processor-controlled device, and/or can be accessed via a wired or wireless network using one or more communications protocols, and, unless otherwise provided, can be arranged to include one or more external and/or one or more internal memory devices, where such memory can be contiguous and/or partitioned based on the application.

Unless otherwise provided, references herein to a/the processor and a/the microprocessor can be understood to include one or more processors that can communicate in stand-alone and/or distributed environment(s) and can be configured to communicate via wired and/or wireless communications with one or more other processors, where such one or more processor can be configured to operate on one or more processor-controlled devices that can include similar or different devices. Use of such processor and microprocessor terminology can be understood to include a central processing unit, an arithmetic logic unit, an application-specific integrated circuit, and/or a task engine, with such examples provided for illustration and not limitation.

Unless otherwise provided, use of the articles “a” or “an” herein to modify a noun can be understood to include one or more than one of the modified noun.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims. Accordingly, the systems and methods described herein are not to be limited to the embodiments described herein, can include practices other than those described, and are to be interpreted as broadly as allowed under prevailing law.

1. A method for providing verified tax data, the method comprising:
providing one or more databases of verified tax data files, where each verified tax data file: (1) includes verified tax data of a taxpayer and (2) is associated with a taxpayer identifier identifying the taxpayer and one or more requesting party identifiers, the requesting party identifiers identifying respective requesting parties having access rights to the verified tax data file,
receiving a request from a first requesting party for verified tax data of a first taxpayer,
based on the request, querying the one or more databases to determine whether they include one or more verified tax data files that are associated with a first taxpayer identifier and a first requesting party identifier, and
providing the verified tax data included in the found one or more verified tax data files to the first requesting party.

2. The method of claim 1, wherein the verified tax data included in each of the verified tax data files are based on one or more data elements from one or more tax forms filed by a taxpayer with a governmental tax collection entity.

3. The method of claim 1, wherein the verified tax data included in each of the verified tax data files are based on one or more data elements from one or more verified tax transcripts of the U.S. Internal Revenue Service (IRS).

4. The method of claim 3, wherein the one or more verified tax transcripts of the IRS are obtained based on a requesting party providing one or more of: an IRS Form 4506, an IRS Form 8821, and another similar IRS form executed by a taxpayer.

5. The method of claim 4, wherein the one or more verified tax transcripts of the IRS are digitized based on one or more of: one or more optical character recognition schemes and one or more manual data entry schemes.

6. The method of claim 1, wherein, for one or more of the verified tax data files, the taxpayer includes one of: an individual taxpayer and a non-personal taxpayer.

7. The method of claim 1, wherein, for one or more of the verified tax data files, the taxpayer includes a joint taxpayer.

8. The method of claim 7, wherein the taxpayer identifier identifies one or more of: a first individual taxpayer associated with the joint taxpayer, a second individual taxpayer associated with the joint taxpayer, and the joint taxpayer.

9. The method of claim 1, further comprising:
based on not finding one or more verified tax data files that are associated with the first taxpayer identifier and the first requesting party identifier, returning to querying the one or more databases.

10. The method of claim 9, wherein returning to querying the one or more databases includes:
querying the one or more databases based on one or more updates to the one or more databases.

11. The method of claim 9, wherein returning to querying the one or more databases includes:
storing the request from the first requesting party for the verified tax data of the first taxpayer,
receiving additional verified tax data files, where each of the additional verified tax data files: (1) includes verified tax data associated with a taxpayer and (2) is associated with a taxpayer identifier identifying the taxpayer and one or more requesting party identifiers, the requesting party identifiers identifying one or more requesting parties having access rights to the verified tax data file, and
determining whether one or more of the additional verified tax data files are associated with the first taxpayer identifier and the first requesting party identifier.

12. The method of claim 11, wherein determining includes:
updating the one or more databases to include the additional verified tax data files.

13. The method of claim 1, further comprising:
based on not finding one or more data files that are associated with the first taxpayer identifier, performing:
storing the request from the first requesting party for the verified tax data of the first taxpayer,
transmitting a verified tax data request for the verified tax data to a provider of verified tax data, the verified tax data request including the first taxpayer identifier and an authorization from the first taxpayer authorizing the provider to provide the verified tax data, and
based on the verified tax data request, receiving the verified tax data from the provider.

14. The method of claim 13, wherein the verified tax data request includes one or more of: an IRS Form 4506, an IRS Form 8821, and another similar IRS form executed by the first taxpayer.

15. The method of claim 13, wherein receiving the verified tax data includes:
receiving one or more electronic transcripts summarizing the verified tax data.

16. The method of claim 15, further comprising:
based on one or more digitizing schemes, digitizing the one or more electronic transcripts of the verified tax data,
based on one or more verification schemes, verifying the digitized electronic transcripts to generate verified tax data files,
associating the verified tax data files with the first taxpayer identifier and the first requesting party identifier, and
updating the one or more databases based on the verified tax data files.

17. The method of claim 1, wherein providing one or more databases of verified tax data files includes:
receiving additional verified tax data files, where each of the additional verified tax data files: (1) includes verified tax data of a taxpayer and (2) is associated with a taxpayer identifier identifying the taxpayer and one or more requesting party identifiers, the requesting party identifiers identifying one or more respective requesting parties having access rights to the verified tax data file, and
updating the one or more databases to include the additional verified tax data files.

18. The method of claim 1, further comprising:
based on applying one or more computation rules to the verified tax data of the first taxpayer, computing a cash flow of the first taxpayer, and
providing the cash flow to the first requesting party.

19. The method of claim 1, further comprising:
querying the first requesting party to provide financial data associated with one or more of incomes and expenses of the first taxpayer, other than incomes and expenses included in verified tax data.

20. The method of claim 19, further comprising:
performing one or more of:
querying to provide one or more cash flow computation options, and providing one or more selectable cash flow computation options, wherein the cash flow computation options are related to a computation treatment of one or more of a non-recurring expense and a non-recurring income, and
computing the cash flow of the first taxpayer based on applying the one or more computation rules and one or more of the one or more provided cash flow computation options and the one or more selected cash flow computation options to the verified tax data and the financial data of the first taxpayer.

21. A system for providing verified tax data, the system comprising:
one or more databases of verified tax data files, where each verified tax data file: (1) includes verified tax data of a taxpayer and (2) is associated with a taxpayer identifier identifying the taxpayer and one or more requesting party identifiers, the requesting party identifiers identifying one or more respective requesting parties having access rights to the verified tax data file, and
a server in communication with the one or more databases, the server configured to:
receive a request from a first requesting party for verified tax data of a first taxpayer,
based on the request, query the one or more databases to determine whether they include one or more verified tax data files that are associated with a first taxpayer identifier and a first requesting party identifier, and
provide the verified tax data included in the found one or more verified tax data files to the first requesting party.

22. The system of claim 21, wherein the verified tax data included in each of the verified tax data files are based on one or more data elements from one or more tax forms filed by a taxpayer with a governmental tax collection entity.

23. The system of claim 21, wherein the verified tax data included in each of the verified tax data files are based on one or more data elements from one or more verified tax transcripts of the U.S. Internal Revenue Service (IRS).

24. The system of claim 23, wherein the one or more verified tax transcripts of the IRS are obtained based on a requesting party providing one or more of: an IRS Form 4506, an IRS Form 8821, and another similar IRS form executed by a taxpayer.

25. The system of claim 24, wherein the one or more verified tax transcripts of the IRS are digitized based on one or more of: one or more optical character recognition schemes and one or more manual data entry schemes.

26. The system of claim 21, wherein, for one or more of the verified tax data files, the taxpayer includes an individual taxpayer.

27. The system of claim 21, wherein, for one or more of the verified tax data files, the taxpayer includes a joint taxpayer.

28. The system of claim 27, wherein the taxpayer identifier identifies one or more of: a first individual taxpayer associated with the joint taxpayer, a second individual taxpayer associated with the joint taxpayer, and the joint taxpayer.

29. A processor program for providing verified tax data, the processor program being stored on a processor readable medium and including instructions to cause a processor to:
access one or more databases of verified tax data files, where each verified tax data file: (1) includes verified tax data associated with a taxpayer and (2) is associated with a taxpayer identifier identifying the taxpayer and one or more requesting party identifiers, the requesting party identifiers identifying one or more respective requesting parties having access rights to the verified tax data file,
receive a request from a first requesting party for verified tax data of a first taxpayer,
based on the request, query the one or more databases to determine whether they include one or more verified tax data files that are associated with a first taxpayer identifier and a first requesting party identifier, and
provide the verified tax data included in the found one or more verified tax data files to the first requesting party.

30. The processor program of claim 29, wherein the verified tax data included in each of the verified tax data files are based on one or more data elements from one or more tax forms filed by a taxpayer with a governmental tax collection entity.

31. The processor program of claim 29, wherein the verified tax data included in each of the verified tax data files are based on one or more data elements from one or more verified tax transcripts of the U.S. Internal Revenue Service (IRS).

32. The processor program of claim 31, wherein the one or more verified tax transcripts of the IRS are obtained based on a requesting party providing one or more of: an IRS Form 4506, an IRS Form 8821, and another similar IRS form executed by a taxpayer.

33. The processor program of claim 32, wherein the one or more verified tax transcripts of the IRS are processed based on one or more of: one or more optical character recognition schemes and one or more manual entry schemes.

34. The processor program of claim 29, wherein, for one or more of the verified tax data files, the taxpayer includes an individual taxpayer.

35. The processor program of claim 29, wherein, for one or more of the verified tax data files, the taxpayer includes a joint taxpayer.

36. The processor program of claim 35, wherein the taxpayer identifier identifies one or more of: a first individual taxpayer associated with the joint taxpayer, a second individual taxpayer associated with the joint taxpayer, and the joint taxpayer.

37. The processor program of claim 29, further comprising instructions to cause a processor to:
based on not finding one or more verified tax data files that are associated with the first taxpayer identifier and the first requesting party identifier, return to querying the one or more databases.

38. The processor program of claim 37, wherein the instructions to return to querying the one or more databases include instructions to:
query the one or more databases based on one or more updates to the one or more databases.

39. The processor program of claim 37, wherein the instructions to return to querying the one or more databases include instructions to:
store the request from the first requesting party for the verified tax data of the first taxpayer,
receive additional verified tax data files, where each of the additional verified tax data files: (1) includes verified tax data associated with a taxpayer and (2) is associated with a taxpayer identifier identifying the taxpayer and one or more requesting party identifiers identifying one or more requesting parties having access rights to the verified tax data file, and
determine whether one or more of the additional verified tax data files are associated with the first taxpayer identifier and the first requesting party identifier.

40. The processor program of claim 39, wherein the instructions to determine include instructions to:
update the one or more databases to include the additional verified tax data files.
